(19) United States
(12) Patent Application Publication
(10) Pub. No.: US 2016/0172954 A1
(43) Pub. Date: Jun. 16, 2016

(54) POWER PLANT COMBINING MAGNETOHYDRODYNAMIC GENERATOR AND GAS TURBINE

(71) Applicant: General Electric Company, Schenectady, NY (US)

(72) Inventors: Joseph Anthony Cotroneo, Clifton Park, NY (US); Robert Frank Hoskin, Duluth, GA (US); Chiranjeev Singh Kalra, Niskayuna, NY (US); Robert Carl Murray, Rotterdam, NY (US)

(21) Appl. No.: 14/571,384

(22) Filed: Dec. 16, 2014

(51) Int. Cl. H02K 44/08; H02K 7/18

(52) U.S. Cl. CPC H02K 44/08; H02K 7/1823

(57) ABSTRACT

A power plant may include a magnetohydrodynamic (MHD) generator having an MHD exhaust that is cooled using a compressor exit flow to a temperature at which the MHD exhaust can be fed to at least one stage of a gas turbine. The heated compressor exit flow may be used to feed a combustor for the MHD generator. In an alternative embodiment, the gas turbine exhaust may be used in a heat recovery steam generator for a steam turbine system, and then fed back to a compressor for the combustor to the MHD generator. In another embodiment, a power plant may include a compressor exit flow feeding a combustor for an MHD generator and an MHD exhaust may be mixed with a compressor pre-exit, extraction flow for feeding to at least one stage of a gas turbine.

### BACKGROUND OF THE INVENTION

The disclosure relates generally to power plants, and more particularly, to a power plant using magnetohydrodynamic generator exhaust to feed at least one stage of a gas turbine.

Gas turbines generate power in conjunction with a generator by extracting mechanical power from a combusted fuel using a set of turbines coupled to a generator by a rotating shaft. Steam turbines work in a similar fashion by extracting mechanical power from a steam flow. Magnetohydrodynamic (MHD) generators convert thermal energy and kinetic energy of a conductive plasma flow, e.g., very hot gases, directly into electric power. MHD generators are different from turbines in that they rely on moving a conductor in the form of the conductive plasma flow through a magnetic field to create electric power, and therefore have no moving mechanical parts.

MHD generators may be used in combination with gas turbines and steam turbines in a number of ways to improve overall power plant efficiency. In one approach, an MHD generator is used to generate electric power as a topping cycle for a steam turbine power plant. Here, the very hot MHD generator exhaust may be used to create steam for the steam turbine system to increase efficiency, e.g., using a heat recovery steam generator (HRSG). In another approach, the very hot MHD generator exhaust may be used to pre-heat an airflow used to feed a combustor that feeds combusted fuel back to the MHD generator and then to the gas turbine.

### BRIEF DESCRIPTION OF THE INVENTION

A first aspect of the disclosure provides a power plant comprising: a gas turbine (GT) for powering a rotating shaft, the gas turbine having a gas turbine exhaust; a magnetohydrodynamic (MHD) generator having an MHD exhaust; a combustor operatively coupled to the MHD generator for creating a flow with a working fluid for powering the MHD generator; a compressor for creating a compressor exit flow; a heat exchanger exchanging heat between the MHD exhaust and the compressor exit flow to cool the MHD exhaust using the compressor exit flow and heat the compressor exit flow using the MHD exhaust; a first conduit for delivery of the compressor exit flow exiting the heat exchanger to the combustor; and a second conduit for delivery of the MHD exhaust exiting the heat exchanger to at least one stage of the gas turbine.

A second aspect of the disclosure provides a power plant comprising: a gas turbine (GT) for powering a rotating shaft, the gas turbine having a gas turbine exhaust; a magnetohydrodynamic (MHD) generator having an MHD exhaust; a combustor operatively coupled to the MHD generator for creating a flow with a working fluid for powering the MHD generator; a compressor for creating a compressor exit flow and a compressor pre-exit flow; a first conduit for delivery of a mix of the MHD exhaust and the compressor pre-exit flow to at least one stage of the gas turbine; and a second conduit for delivery of the compressor exit flow to the combustor.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a schematic view of one embodiment of a gas turbine power plant according to embodiments of the invention.

FIG. 2 shows a schematic view of an embodiment of a combined cycle power plant including features of the FIG. 1 embodiment.

FIG. 3 shows a schematic view of another embodiment of a gas turbine power plant according to embodiments of the invention.

FIG. 4 shows a schematic view of an embodiment of a combined cycle power plant including features of the FIG. 3 embodiment.

FIG. 5 shows a schematic view of the FIG. 2 embodiment with exhaust gas recirculation according to embodiments of the invention.

FIG. 6 shows a schematic view of the FIG. 4 embodiment with exhaust gas recirculation according to embodiments of the invention.

FIG. 7 shows a schematic view of the FIG. 1 embodiment with a closed loop system according to embodiments of the invention.

FIG. 8 shows a schematic view of the FIG. 3 embodiment with a closed loop system according to embodiments of the invention.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As indicated above, the disclosure provides a power plant including a magnetohydrodynamic (MHD) generator. In one embodiment, an MHD exhaust is cooled using a compressor exit flow to a temperature at which the MHD exhaust can be fed to at least one stage of a gas turbine. The heated compressor exit flow may be used to feed a combustor for the MHD generator. In an alternative embodiment, the gas turbine exhaust may be used in a heat recovery steam generator (HRSG) for a steam turbine system. In addition, in other embodiments, the gas turbine exhaust exiting the HRSG may be fed back to a compressor for the combustor to the MHD generator. In another embodiment, a power plant may include a compressor exit flow feeding a combustor for an MHD generator and an MHD exhaust may be mixed with a compressor pre-exit, extraction flow for feeding to at least one stage of a gas turbine. This latter embodiment may also include a combined cycle version and an exhaust gas recirculation version.

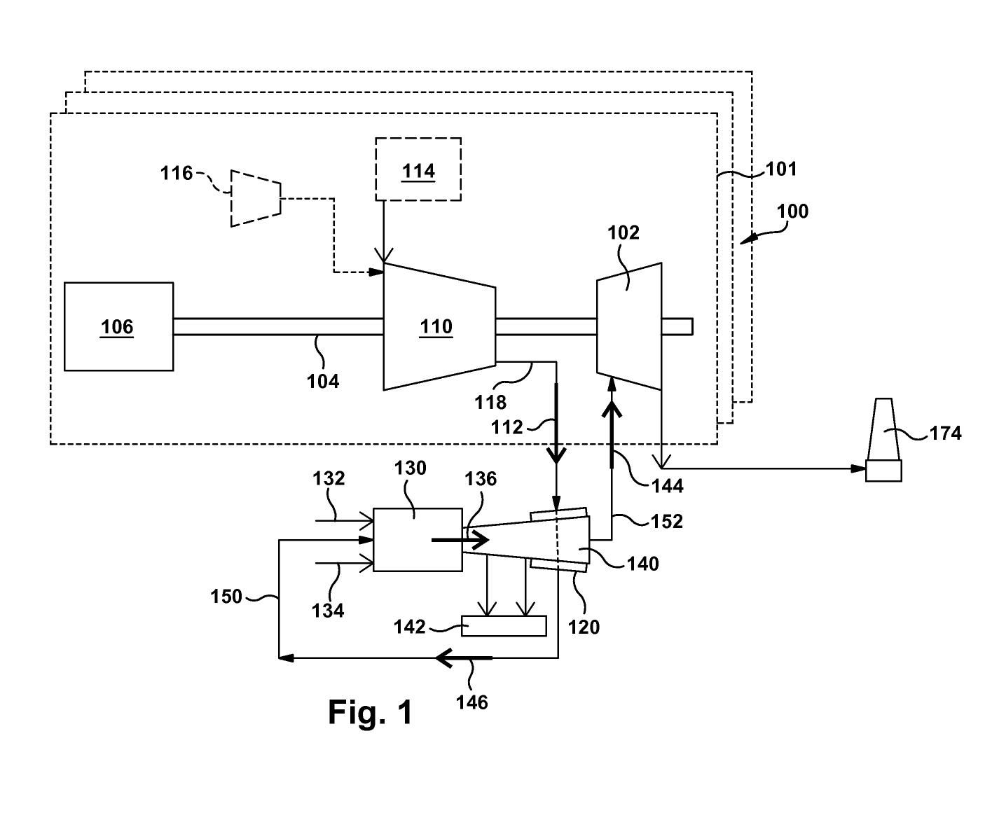

Referring to FIG. 1, a schematic view of one embodiment of a power plant 100 according to embodiments of the invention is illustrated. Power plant 100 may include a gas turbine system 101 including a gas turbine (GT) 102 for powering a rotating shaft 104. Gas turbine 102 may include any now known or later developed gas powered turbine configured to operate with MHD generator 140. In contrast to conventional power plants that utilize gas turbines, however, power plant 100 does not include an integral combustor. While a single gas turbine system 101 will be described herein, it is understood that gas turbine system 101 may include a plurality of gas turbine systems (shown by layered boxes 101 in the drawings) operatively coupled to a single rotating shaft 104 coupled to a single load 106. Alternatively, each gas turbine system 101 may be operatively coupled to its own rotating shaft, each perhaps coupled to its own generator. That stated, any conventional arrangement of gas turbine(s) 102, rotating shaft(s) 104 and load(s) 106 may be employed.

In the embodiments described herein, load 106 has been described as a generator that is coupled to rotating shaft 104 to generate electric power from gas turbine 102. The generator may include any now known or later developed electric generator. It is understood that other forms of a load may also be employed within the scope of the invention, e.g., a machine transmission, other industrial machine, etc.

Power plant 100 may also includes a compressor 110 for creating a compressor exit flow 112, i.e., a flow having greater pressure than that entering the compressor. Compressor exit flow 112 includes a compressed gas flow that has been exposed to most, if not all, of the compression stages of compressor 110. Compressor 110 may use air as a working fluid and use conventional air intake systems, e.g., filters, noise reduction, moisturizing, etc. In an alternative embodiment, compressor 110 may be operatively coupled to, for example, an oxygen separation system 114 such that compressor exit flow 112 may include air with oxygen. Oxygen separation system 114 may include any now known or later developed system for generating purified oxygen. Oxygen separation system 114 can include, for example, a cryogenic unit including one or more distillation elements capable of supplying gaseous stream(s) including a majority of oxygen. In one particular embodiment, compressor exit flow 112 may include mostly oxygen. Alternatively, other gases may be used within power plant 100 in a closed loop, or open arrangement. For example, another gas may include carbon dioxide. Compressor 110 may be powered by rotating shaft 104. In alternative embodiments, compressor 110 may include a dual spool compressor, i.e., with two sets of turbines, or a main compressor 110 with a booster compressor 116 (shown in phantom). Booster compressor 116 may be driven by a transmission from rotating shaft 104 or another power source. An exhaust or flue gas vent 174 may be utilized to extract a portion of the working gases commensurate with the amount of air or oxygen brought into the cycle, wherein a desired pressure within the cycle is maintained. As will be described herein, in the FIG. 1 embodiment, among others, compressor exit flow 112 may be delivered by a conduit 118 to a heat exchanger 120.

In contrast to conventional power plants, a combustor 130 is not coupled directly to gas turbine 102 but is operatively coupled to a magnetohydrodynamic (MHD) generator 140 for creating a flow with a working fluid in the form of, for example, a conductive plasma flow, for powering the MHD generator. Combustor 130 may create any now known or later developed conductive plasma flow for MHD generator 140. In one embodiment, combustor 130 receives a seed (or injected plasma) material flow 132 and a fuel 134 that is combusted in a conventional manner to create a conductive plasma flow 136. For example, conductive plasma flow 136 may be created by thermal ionization, in which the temperature of the gas is high enough to separate the electrons from the atoms of gas. Plasma flow 136 is electrically conductive because of the free electrons therein. Plasma flow 136 generation requires very high temperatures, the extent of which can be lowered by seeding or injecting with an alkali metal compound, e.g., potassium carbonate, which ionizes more easily at lowered temperatures. Seed material flow 132 may be recovered and recycled downstream of MHD generator 140 in a conventional manner. Fuel 134 may include any variety of combustible fuel such as but not limited to: natural gas, coal, oil, integrated gasification combined cycle (IGCC) fuel, etc. As will be described herein, a heated compressor exit flow 146 may also be fed to combustor 130.

MHD generator 140 may include any now known or later developed electric generator capable of converting thermal energy and kinetic energy of conductive plasma flow 136 directly into electric power without moving parts. For example, MHD generator 140 may include but is not limited to: a Faraday-type MHD generator, a segmented Faraday-type MHD generator, a Hall-type MHD generator, and a disk-type MHD generator. A segmented Faraday-type MHD generator may include, for example, a non-conductive duct having an acceleration nozzle (e.g., Venturi) through which conductive plasma flow 136 passes. Downstream of the acceleration nozzle, a set of segmented electrodes extends about the plasma flow path in the duct within a strong perpendicular, magnetic field. The magnetic field may be created, for example, by a number of solenoids. As the conductive plasma flow 136 passes through the magnetic field, it creates an electric flow in the segmented electrodes. There are no moving parts. A Hall-type MHD generator works similarly to the segmented Faraday-type device but places an array of vertical electrodes on the duct sides, some of which are shorted to reduce losses. A disk-type MHD generator, also known as a Hall affect disk generator, flows conductive plasma flow 136 between a center of a disk, and a duct positioned around an edge of the disk. A pair of Helmholtz coils may be used to create the magnetic field below and above the disk. Current can be pulled from ring electrodes near the periphery and center of the disk. It is emphasized that while a number of particular MHD generators have been briefly described that the teachings of the invention are applicable to any form of MHD generator now known or later developed. In any event, it is understood, MHD generators operate at very high temperatures, e.g., greater than 2480° C. Consequently, a conventional MHD exhaust cannot, as is, be used to power gas turbine 102, which typically operates at below 1540° C. In addition, as MHD generator 140 creates direct current electric power, an inverter 142 is typically provided to convert the electric power to alternating current. Inverter 142 may include any now known or later developed system for conditioning and inverting direct current to alternating current for feeding to conventional power distribution systems along with power generated by a generator, i.e., load 106.

In accordance with embodiments of the invention, power plant 100 includes a heat exchanger 120 exchanging heat between an MHD exhaust 144 and compressor exit flow 112 to cool MHD exhaust 144 using compressor exit flow 112 and heat compressor exit flow 112 using MHD exhaust 144. The result is a cooled, MHD exhaust 144 in the range of approximately 1050° C. to approximately 1540° C. The compressor exit flow is heated commensurate with the change in enthalpy of the MHD exhaust in the heat exchanger, thus reducing the amount of fuel needed in the combustor. Heat exchanger 120 can take any form capable of exchanging heat between the two streams, and may be integral or separate from MHD generator 140. Heat exchanger 120 does not allow intermixing of MHD exhaust 144 and compressor exit flow 112.

A first conduit 150 delivers heated, compressor exit flow 146 exiting heat exchanger 120 to combustor 130 for use in creating conductive plasma flow 136. In this fashion, a more efficient combustion using a heated, flow 146 can be obtained. In addition, a second conduit 152 delivers cooled, MHD exhaust 144 exiting heat exchanger 120 to at least one stage of gas turbine(s) 102 to power the gas turbine. Cooled MHD exhaust 144 can be injected to gas turbine(s) 102 in any now known or later developed fashion, and to all or any number of stages of the gas turbine. No other combustion flow needs to be provided. Power plant 100 thus takes advantage of MHD exhaust 144 in number of ways. First, the high pressure MHD exhaust 144, rather than simply being used as a heat source, is leveraged to directly power gas turbine(s) 102. For example, MHD exhaust 144 may exhibit a pressure in the range of approximately 0.4 MegaPascal (MPa) to approximately 3 MPa. Second, MHD generator 140 may be operated at a very high firing temperature, e.g., above approximately 2500° C., creating a very hot conductive plasma flow 136, thus improving efficiency thereof while also allowing excess heat to be advantageously transferred to compressor exit flow 112 for use by combustor 130.

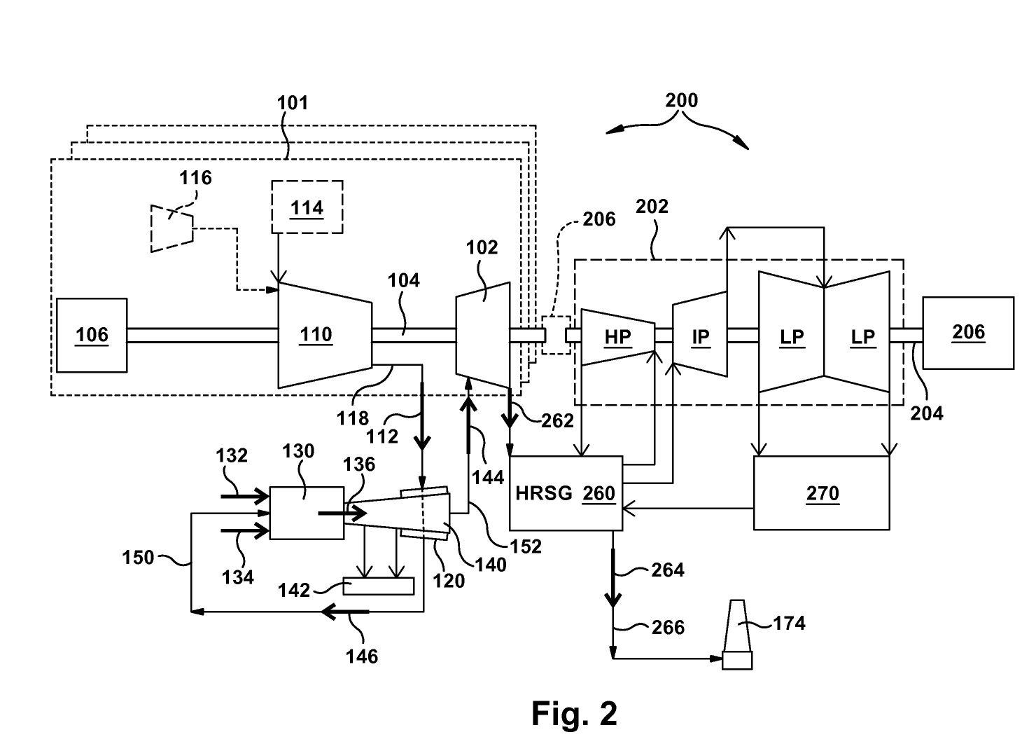

Referring to FIG. 2, in another embodiment of the invention, a combined cycle power plant 200 including the above-identified structure and a steam turbine 202 operatively coupled to gas turbine(s) 102, may be provided. Steam turbine 202 may include any now known or later developed steam turbine system. In the example shown, steam turbine 202 includes a high pressure (HP) section, an intermediate pressure (IP) section and a low pressure (LP) section. It is understood that not all sections are necessary. In the example shown, the loads are provided in the form of a first generator 106 and a second generator 206. Here, gas turbine(s) 102 is/are operatively coupled by rotating shaft 104 to first generator 106, and steam turbine 202 is operatively coupled by a separate rotating shaft 204 to second generator 206. As understood in the field, a single generator could be operatively coupled to both steam turbine 202 and gas turbine(s) 102, i.e., where a single rotating shaft or a coupled rotating shaft (via a transmission 206) are employed. That stated, any conventional arrangement of gas turbine(s) 102, steam turbine(s) 202, rotating shaft(s) 104, 204 and load(s) 106, 206 may be employed.

Power plant 200 may also include a heat recovery steam generator (HRSG) 260 receiving a gas turbine exhaust 262 to generate steam for steam turbine 202. HRSG 260 may include any now known or later developed system to recover energy from a hot gas stream so it can be used to produce steam. In this fashion, gas turbine exhaust 262 feeds a bottoming, Rankine steam cycle. The use of MHD exhaust 144 in gas turbine(s) 102 may result in a hotter gas turbine exhaust 262 providing higher efficiency steam generation in HRSG 260. A conventional condenser 270 may be coupled to LP sections to recuperate water to feed HRSG 260.

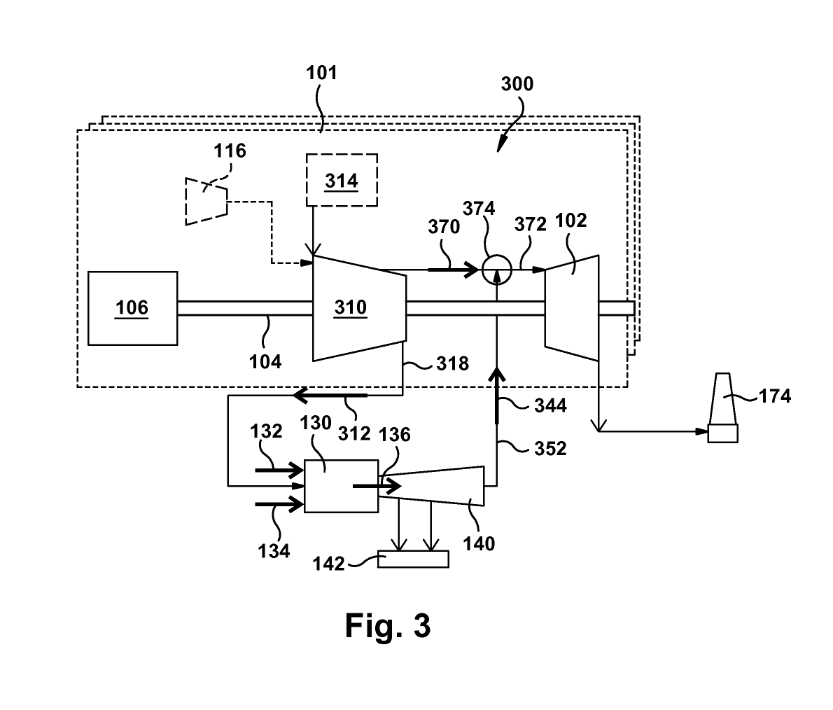

Referring to FIG. 3, another embodiment of a power plant 300 according to the invention is illustrated. As in the FIG. 1 embodiment, power plant 300 includes gas turbine(s) 102 for powering rotating shaft(s) 104. A load 106 such as a generator may be operatively coupled to rotating shaft(s) 104 to create electric power from its rotation. In addition, MHD generator 140 having an MHD exhaust 344 may be provided. Combustor 130 is operatively coupled to MHD generator 140 for creating conductive plasma flow 136 for powering MHD generator 140. In contrast to FIGS. 1 and 2, power plant 300 does not include a heat exchanger 120 (FIGS. 1-2); thus, MHD exhaust 344 is not cooled by the compressor exit flow from the compressor in this embodiment. Rather, in this embodiment, a compressor 310 creates a compressor exit flow 312 and a compressor pre-exit flow 370. As used herein, “compressor exit flow” 312 includes a compressed gas flow that has been exposed to most, if not all, of the compression stages of compressor 310, while “compressor pre-exit flow” 370 includes a less compressed gas flow than compressor exit flow 312 that has been extracted prior to having been exposed to most or all of the stages of compressor 310. Compressor pre-exit flow 370 may also be referred to as an extraction flow. In an optional embodiment, an oxygen separation system 314 may be operatively coupled to compressor 310 such that compressor exit flow 312 and compressor pre-exit flow 370 each can include a majority of oxygen. Oxygen separation system 314 can include, for example, a cryogenic unit including one or more distillation elements capable of supplying gaseous stream(s) including a majority of oxygen. Compressor 310 can otherwise be structured similarly to the options described relative to compressor 110 (FIGS. 1-2).

With continuing reference to FIG. 3, a first conduit 372 delivers a mix of MHD exhaust 344 and compressor pre-exit flow 370 to at least one stage of gas turbine(s) 102. In this fashion, a mix of working fluid from compressor 310 is combined with a MHD exhaust 344 creating a working fluid flow with a temperature suitable for gas turbine 102. The mixing of flow 370 and MHD exhaust 344 may occur in any now known or later developed fashion such as by a mixing element 374 like a mixing valve, a mixing chamber, etc. In one example, mixing element 374 may include an annular mixing scheme similar to that used on an aviation turbofan engine or ramjet engine, where a hot stream is mixed with a cooler bypass stream. The amount of each of compressor pre-exit flow 370 and MHD exhaust 344 in the mixture can be user defined. As also shown in FIG. 3, a second conduit 318 delivers compressor exit flow 312 to combustor 130. Here, the fully compressed working fluid 312 is provided to combustor 130 for creating conductive plasma flow 136 with fuel 134 and seed or injected plasma flow 132, as described relative to FIGS. 1-2. Conducive plasma flow 136 powers MHD generator 140. In operation, electric power is generated by generator/load 106 coupled to gas turbine(s) 102, and inverter 142 coupled to MHD generator 140.

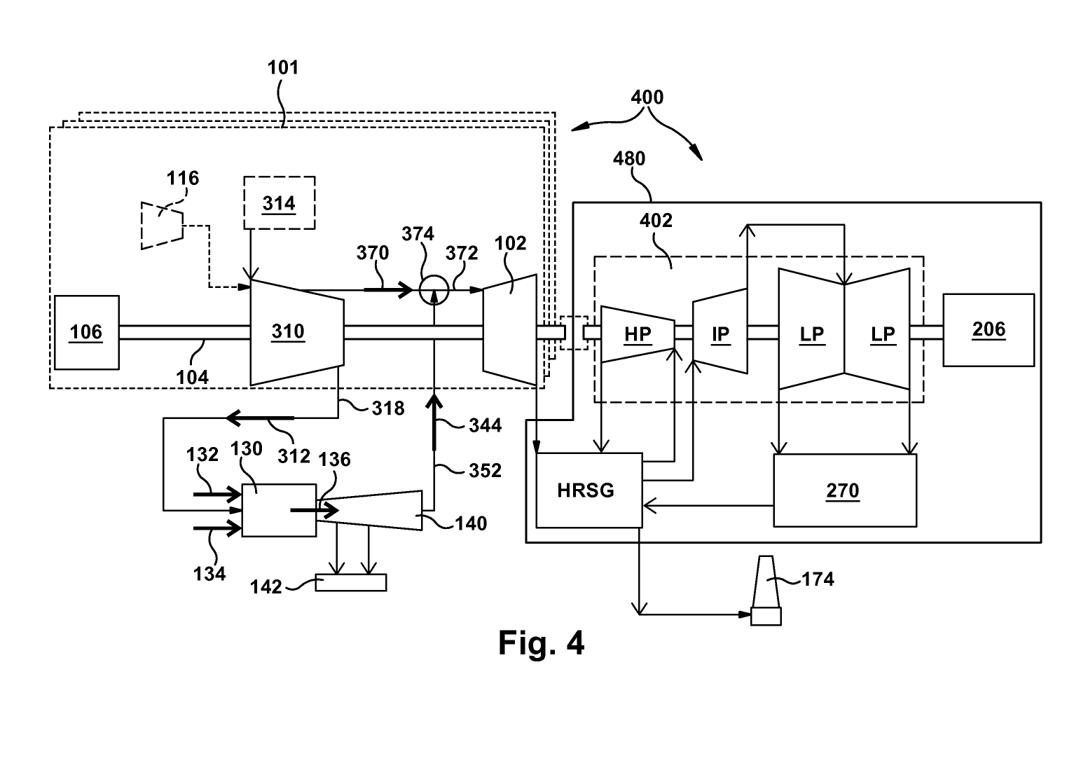

FIG. 4 shows a schematic view of a combined cycle power plant 400 with the system of FIG. 3 and a steam turbine system 480 operatively coupled thereto. That is, steam turbine 402 is operatively coupled to gas turbine(s) 102 as a bottoming cycle. Steam turbine system 480 and steam turbine 402 are substantially identical to the system described relative to FIG. 2. In this example, gas turbine exhaust is released to atmosphere or a carbon capture system (not shown), i.e., there is no exhaust gas recirculation shown.

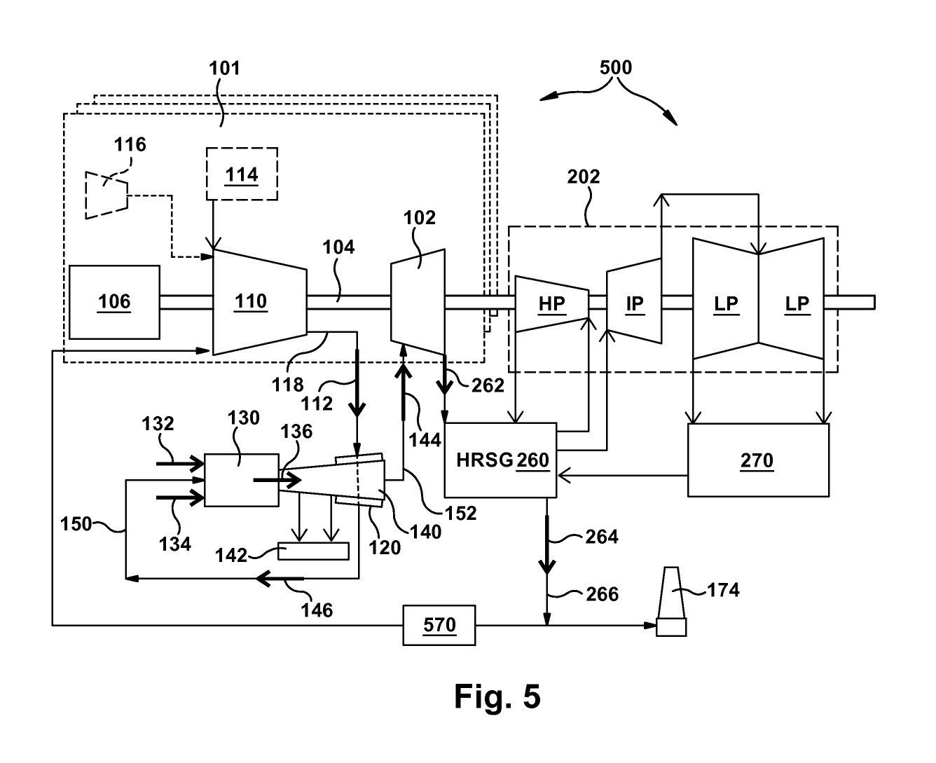

Referring to FIG. 5, in an optional embodiment to that of FIG. 2, rather than gas turbine exhaust 262 exiting to atmosphere or a carbon capture system (not shown) after use in HRSG 260, at least a portion of gas turbine exhaust 264 exiting HRSG 260 may be delivered to an inlet of compressor 110. In particular, a conduit 266 may deliver at least a portion of gas turbine exhaust 264 exiting HRSG 260 to an inlet of compressor 110. In one example, the portion of gas turbine exhaust 264 used may be a majority, e.g., greater than 50%. This process may be referred to as exhaust gas recirculation (EGR). In this fashion, at least a portion of gas turbine exhaust 264 exiting HRSG 260 can provide a compressor inlet flow to increase efficiency of creating a combustion flow for combustor 130. In this embodiment, an optional intercooler 570 may be provided to cool gas turbine exhaust 264 exiting HRSG 260 (compressor inlet flow) prior to entering compressor 110. An exhaust or flue gas vent 174 may be utilized to extract a portion of the working gases commensurate with the amount of air or oxygen brought into the cycle, wherein a desired pressure within the cycle is maintained. As a result of this structure, in one embodiment, gas turbine 102 may use primarily carbon dioxide (CO₂) for its thermodynamic working fluid. A portion of the recycled working gases may be drawn off in a known fashion for further processing or storage to provide a ready means for CO₂ capture or sequestration. Such processing could include but is not limited to further processing to increase CO₂ concentration. Alternatively, it may be desirable to provide a supplemental oxidant feed system for feeding at least one of air and oxygen to compressor 110 so as to provide sufficient oxygen for combustion in combustor 130. For example, an oxygen separation system 114 coupled to compressor 110 may be employed. Alternatively, a higher pressure ratio may be provided to compressor 110 than would typically be necessary, e.g., via a booster compressor 116 or a dual shaft compressor, as described herein. In any event, where gas turbine exhaust 262 is used with steam turbine 202, i.e., as part of a bottoming, Rankine steam cycle, gas turbine exhaust 262 flow exits the turbine section then travels through one or more heat exchangers, e.g., HRSG 260, prior to recirculation to the gas turbine inlet. The high temperature capability of MHD generator 140 incorporated into the EGR gas turbine cycle, i.e., via conduit 266, can provide increased power generation, e.g., through efficiency in conjunction with CO₂ capture or sequestration.

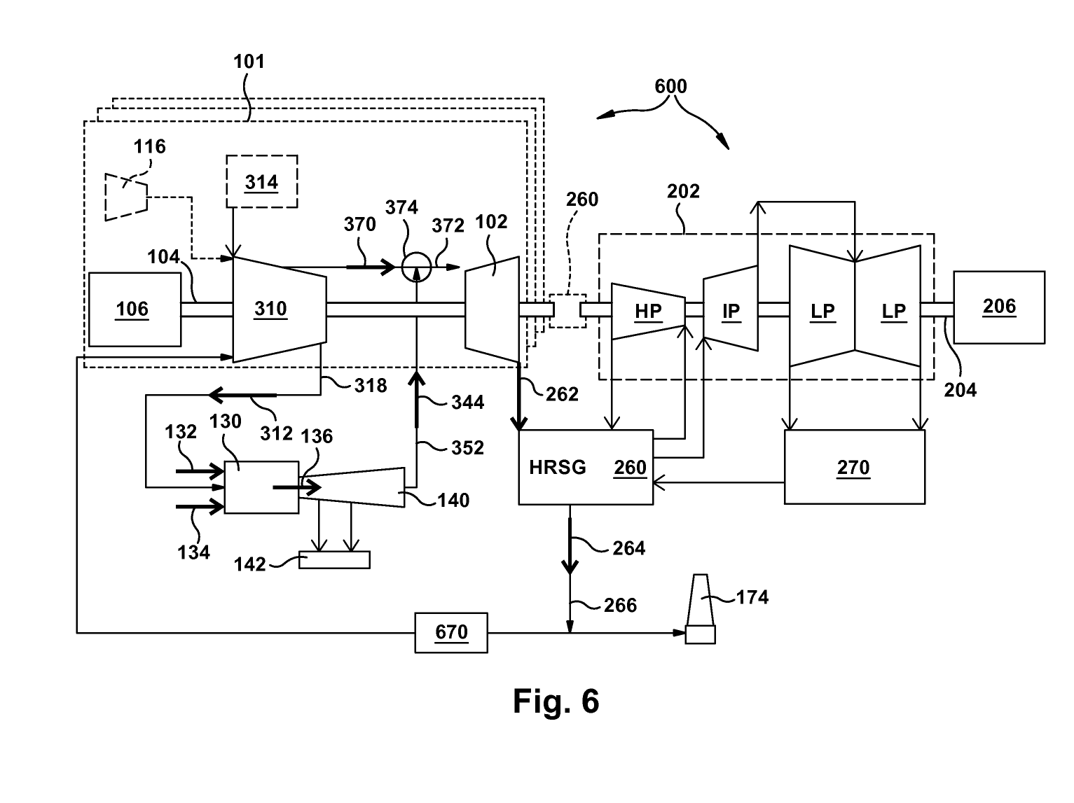

FIG. 6 shows the FIG. 3 embodiment including exhaust gas recirculation. Here, rather than gas turbine exhaust 262 exiting to atmosphere or a carbon capture system (not shown) after use in HRSG 260, at least a portion of gas turbine exhaust 264 exiting HRSG 260 may be delivered to an inlet of compressor 310. In particular, a conduit 266 may deliver at least a portion of gas turbine exhaust 264 exiting HRSG 260 to an inlet of compressor 310. In one example, the portion of gas turbine exhaust 264 used may be a majority, e.g., greater than 50%. In this fashion, at least a portion of gas turbine exhaust 264 exiting HRSG 260 can provide a compressor inlet flow to increase efficiency of creating a combustion flow for combustor 130. In this embodiment, an optional intercooler 670, may be provided to cool gas turbine exhaust 264 exiting HRSG 260 (compressor inlet flow) prior to entering compressor 310. An exhaust or flue gas vent 174 may be utilized to extract a portion of the working gases commensurate with the amount of air or oxygen brought into the cycle, wherein a desired pressure within the cycle is maintained. As a result of this structure, as with the FIG. 5 embodiment, gas turbine 102 may use primarily carbon dioxide (CO₂) for its thermodynamic working fluid. A portion of the recycled working gases may be drawn off as described herein relative to FIG. 5. Alternatively, as also described relative to FIG. 5, it may be desirable to provide a supplemental oxidant feed system for feeding at least one of air and oxygen to compressor 310 so as to provide sufficient oxygen for combustion in combustor 130. Alternatively, a higher pressure ratio may be provided to compressor 310 than would typically be necessary, e.g., via a booster compressor 116 or a dual shaft compressor, as described herein.

While use of gas turbine exhaust 262 to feed HRSG 260 and its recirculation via conduit 266 to compressor 110, 310 have been illustrated as being used together in FIGS. 5 and 6, it is emphasized that combined functionality is not necessary. In another alternative embodiment, gas turbine exhaust 262 could feed back to compressor 110 without feeding HRSG 260, i.e., the bottoming, Rankine steam cycle.

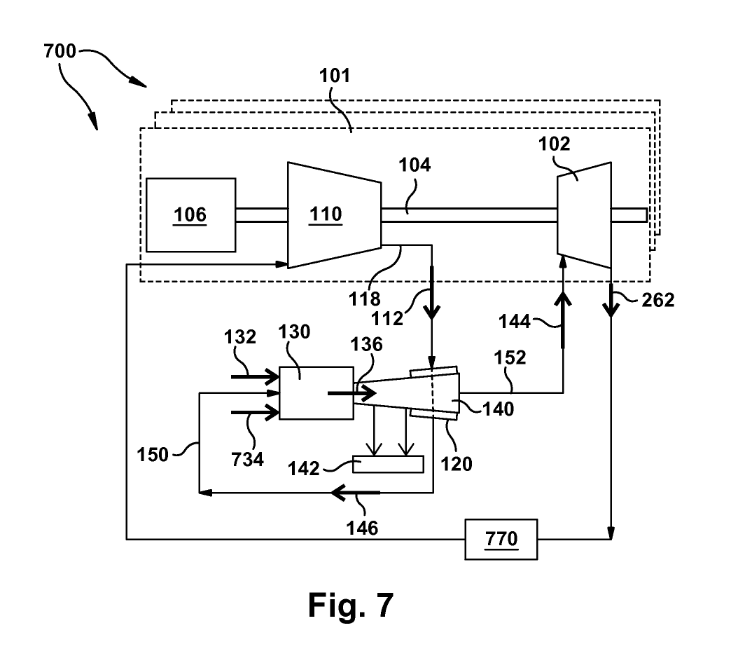

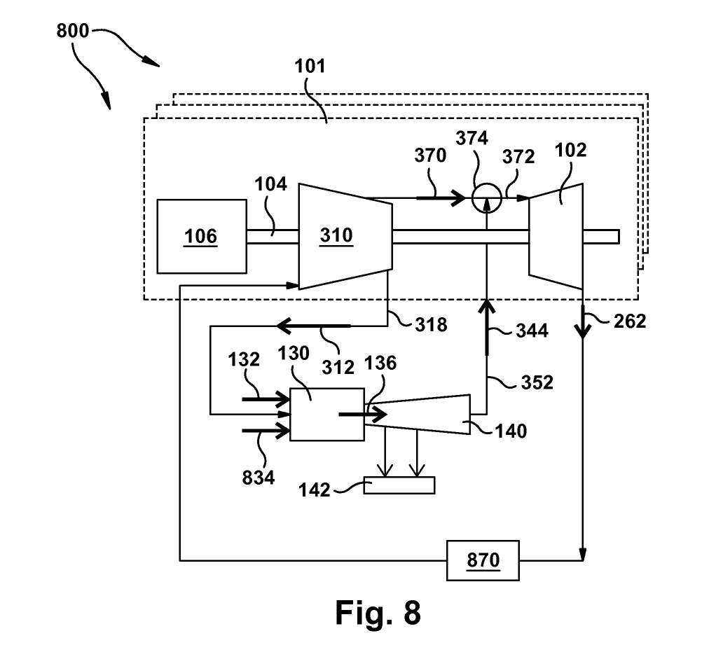

In the foregoing embodiments, the working fluid has been described, in most cases, as air, perhaps with a supplemental oxidant supply system, e.g., oxygen separation plant 114 (FIG. 1) or 314 (FIG. 3). In these settings, the power plants are considered open systems because they pull working fluid, i.e., air/oxygen, from the atmosphere and/or a supply system to operate. It is emphasized, however, that the teachings of the invention may be employed in an open system or a closed loop system. FIG. 7 shows a schematic view of the FIG. 1 embodiment employed as a closed loop, power plant 700; and FIG. 8 shows the FIG. 3 embodiment as a closed loop, power plant 800. In each, a gas turbine exhaust 262 is re-circulated to compressor 110, 310, respectively, in a closed loop. No outside working fluid is drawn into the systems. In these embodiments, a heat source 734 (FIG. 7), 834 (FIG. 8) such as but not limited to nuclear power replaces a fuel flow 134, i.e., no fuel is mixed with the working fluid. In addition, in these embodiments, an optional intercooler 770 (FIG. 7), 870 (FIG. 8) may be provided for gas turbine exhaust 262.

While FIGS. 7 and 8 show power plants 700, 800, respectively, using gas turbine(s) 102 and MHD generator 140 only, it is understood that the systems could also be employed as combined cycle systems with the bottoming, Rankine steam cycle, as described herein relative to FIGS. 2 and 4.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A power plant comprising:
a gas turbine (GT) for powering a rotating shaft, the gas turbine having a gas turbine exhaust;
a magnetohydrodynamic (MHD) generator having an MHD exhaust;
a combustor operatively coupled to the MHD generator for creating a flow with a working fluid for powering the MHD generator;
a compressor for creating a compressor exit flow;
a heat exchanger exchanging heat between the MHD exhaust and the compressor exit flow to cool the MHD exhaust using the compressor exit flow and heat the compressor exit flow using the MHD exhaust;
a first conduit for delivery of the compressor exit flow exiting the heat exchanger to the combustor; and
a second conduit for delivery of the MHD exhaust exiting the heat exchanger to at least one stage of the gas turbine.

2. The power plant of claim 1, wherein the gas turbine includes a plurality of gas turbines, at least one of the gas turbines coupled to the rotating shaft.

3. The power plant of claim 1, wherein the compressor includes one of: a) a dual spool compressor, and b) a main compressor and a booster compressor.

4. The power plant of claim 1, wherein the MHD generator is selected from the group consisting of: a Faraday-type MHD generator, a segmented Faraday-type MHD generator, a Hall-type MHD generator, and a disk-type MHD generator.

5. The power plant of claim 1, further comprising:
a steam turbine operatively coupled to the gas turbine; and
a heat recovery steam generator (HRSG) receiving the gas turbine exhaust to generate steam for the steam turbine.

6. The power plant of claim 5, further comprising:
a third conduit for delivering at least a portion of the gas turbine exhaust exiting the HRSG to an inlet of the compressor; and
a supplemental oxidant feed system for feeding at least one of air and oxygen to the combustor.

7. The power plant of claim 5, wherein the generator is operatively coupled to both the steam turbine and the gas turbine.

8. The power plant of claim 5, wherein the gas turbine includes a plurality of gas turbines operatively coupled to the steam turbine.

9. The power plant of claim 5, further comprising a first generator and a second generator, and the gas turbine is operatively coupled by the rotating shaft to the first generator, and the steam turbine is operatively coupled by a separate rotating shaft to the second generator.

10. The power plant of claim 1, further comprising an oxygen separation system operatively coupled to the compressor and the compressor exit flow includes mostly oxygen.

11. The power plant of claim 1, wherein the working fluid for the power plant is circulated in a closed loop.

12. A power plant comprising:
a gas turbine (GT) for powering a rotating shaft, the gas turbine having a gas turbine exhaust;
a magnetohydrodynamic (MHD) generator having an MHD exhaust;
a combustor operatively coupled to the MHD generator for creating a flow with a working fluid for powering the MHD generator;
a compressor for creating a compressor exit flow and a compressor pre-exit flow;
a first conduit for delivery of a mix of the MHD exhaust and the compressor pre-exit flow to at least one stage of the gas turbine; and
a second conduit for delivery of the compressor exit flow to the combustor.

13. The power plant of claim 12, further comprising an oxygen separation system operatively coupled to the compressor, wherein the compressor exit flow and the compressor pre-exit flow each include mostly oxygen.

14. The power plant of claim 12, wherein the gas turbine includes a plurality of gas turbines, at least one of the gas turbines coupled to the rotating shaft.

15. The power plant of claim 12, wherein the MHD generator is selected from the group consisting of: a Faraday-type MHD generator, a segmented Faraday-type MHD generator, a Hall-type MHD generator, and a disk-type MHD generator.

16. The power plant of claim 12, further comprising a steam turbine operatively coupled to the gas turbine, and a heat recovery steam generator (HRSG) receiving the gas turbine exhaust to generate steam for the steam turbine.

17. The power plant of claim 16, further comprising a first generator and a second generator, and the gas turbine is operatively coupled by the rotating shaft to the first generator, and the steam turbine is operatively coupled by a separate rotating shaft to the second generator.

18. The power plant of claim 16, further comprising:
a third conduit for delivering at least a portion of the gas turbine exhaust exiting the HRSG to an inlet of the compressor; and
a supplemental oxidant feed system for feeding at least one of air and oxygen to the combustor.

19. The power plant of claim 12, wherein the working fluid for the power plant is circulated in a closed loop.
